(19) United States
(12) Patent Application Publication
(10) Pub. No.: US 2026/0066610 A1
(43) Pub. Date: Mar. 5, 2026

(54) Optical Frequency Comb Generation Apparatus and Method

(71) Applicant: UCL Business LTD, London (GB)

(72) Inventors: Zhixin LIU; Callum DEAKIN; Ronit SOHANPAL

(21) Appl. No.: 19/104,198

(22) PCT Filed: Aug. 15, 2023
(86) PCT No.: PCT/GB2023/052147

§ 371 Date: Feb. 14, 2025

(30) Foreign Application Priority Data
Aug. 17, 2022 (GB) 2212004.2

(51) Int. Cl. H01S 3/13; G02F 1/01; H01S 3/10

(52) U.S. Cl. CPC H01S 3/1305; G02F 1/0121; H01S 3/10015; G02F 2203/56

(57) ABSTRACT

An optical comb generator receives light from at least two continuous wave laser sources, produces a different frequency comb from each laser source, and produces an output that it the simultaneous combination of the different frequency combs. The different frequency combs span different frequency bands, but at least partially overlap in frequency with an adjacent comb in a region of overlap. A spectral filter produces a filtered output that has at least one pair of tones from the region of overlap, the pair of tones comprising one tone from each of two adjacent combs. Feedback control based on the filtered output is applied to adjust the light entering the comb generator such that the frequencies and phases of the pair of tones from the region of overlap are aligned. In this way, the multiple different overlapping combs are stitched together to form a single seamless comb spanning a broader frequency range.

The present invention relates to optical frequency comb generation.

Frequency combs have found applications in numerous fields, for example, metrology, spectroscopy, microwave electronics, sensing, medical imaging, instrumentation, wireless and optical communications. For example, in the field of optical communications, significant cost and energy savings can be made by replacing a bank of N lasers (for example N=64, but N can be several hundred) with a single frequency comb. The coherent nature of the comb lines (phase of comb tones are correlated) as well as the equal frequency spacing of the comb tones, offers the prospect of ultra-high spectral efficiency (thus high capacity, fast networks), and the generation of electronic radio-frequency carriers with high purity, for linking optical systems to wireless systems. In many applications, the comb source needs to have sufficiently high optical power, low noise, and flat spectrum (i.e. similar power for all the tones) to enable these benefits to be achieved.

There is a problem to generate a frequency comb with these properties, such as a large number of tones, each with adequate and similar optical power, over a relatively wide band of frequencies.

It can also be a problem to generate a comb that is tunable in wavelength, bandwidth, and tone spacing.

The present invention has been devised in view of the above problems.

Accordingly, the present invention provides an optical frequency comb generation apparatus comprising:
a comb generator arranged to receive light simultaneously from a plurality of continuous wave laser sources of different frequency, and to produce a combined output comprising a combination of a plurality of frequency combs, one comb for each laser source, wherein the frequency combs span different frequency bands, and wherein the comb from a first laser source at least partially overlaps in frequency with an adjacent comb from a second laser source in a region of overlap;
a spectral filter arranged to receive a portion of the combined output and to selectively produce a filtered output comprising at least one pair of tones from the region of overlap, the pair of tones comprising one tone from the comb from the first laser source and one tone from the comb from the second laser source;
a feedback control apparatus arranged to receive the filtered output of the spectral filter and to produce, based on the filtered output, at least one control signal arranged to adjust the light entering the comb generator such that the frequencies and phases of the pair of tones from the region of overlap are substantially aligned.

Another aspect of the invention provides a method of generating an optical frequency comb comprising:
passing light simultaneously from a plurality of continuous wave laser sources of different frequency through a comb generator to produce a combined output comprising a combination of a plurality of frequency combs, one comb for each laser source, wherein the frequency combs span different frequency bands, and wherein the comb from a first laser source at least partially overlaps in frequency with an adjacent comb from a second laser source in a region of overlap;
spectrally filtering a portion of the combined output to produce a filtered output comprising at least one pair of tones from the region of overlap, the pair of tones comprising one tone from the comb from the first laser source and one tone from the comb from the second laser source;
applying feedback control, based on the filtered output of the spectral filter, to produce at least one control signal arranged to adjust the light entering the comb generator such that the frequencies and phases of the pair of tones from the region of overlap are substantially aligned.

A further aspect of the invention provides an optical frequency comb generator comprising:
a series of cascaded optical modulators comprising at least one phase modulator and at least one intensity modulator or intensity-modulated laser source;
a generator for generating an oscillatory electrical signal for driving the modulators; and
an adjustment apparatus arranged to adjust the oscillatory electrical signal applied to at least one of the modulators.

Further optional aspects of the invention are defined in the dependent claims.

Embodiments of the invention will now be described, by way of example only, with reference to the accompanying drawings, in which:

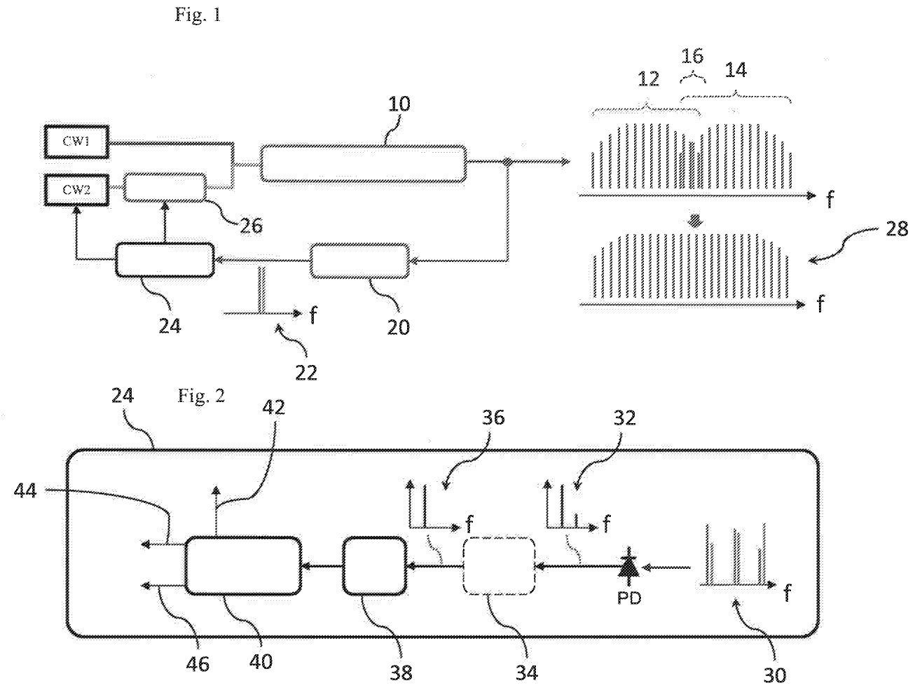

FIG. 1 is a schematic illustration of an apparatus for generating an optical frequency comb using two laser sources as seeds, according to an embodiment of the invention;

FIG. 2 is a schematic illustration of an embodiment of a feedback control apparatus for use in the embodiment of FIG. 1;

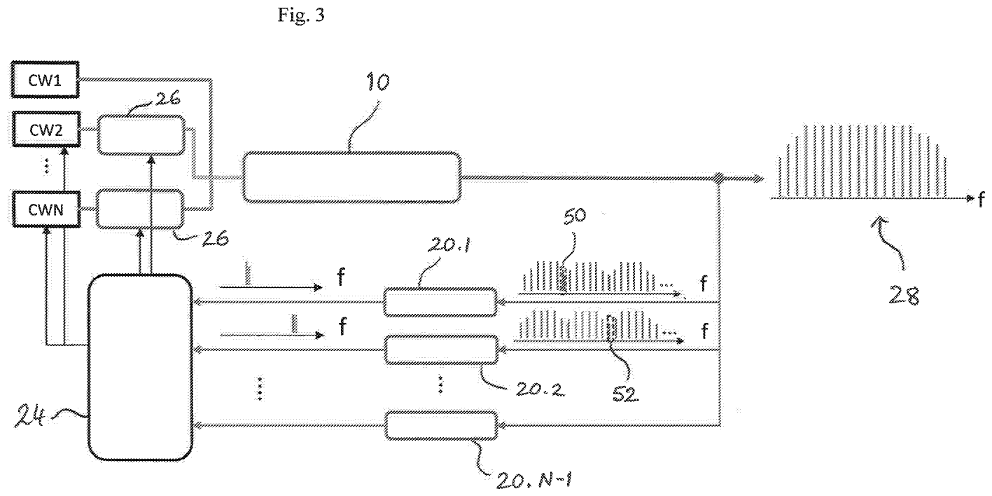

FIG. 3 is a schematic illustration of an apparatus for generating an optical frequency comb using multiple laser sources as seeds, as an extension of FIG. 1, according to an embodiment of the invention;

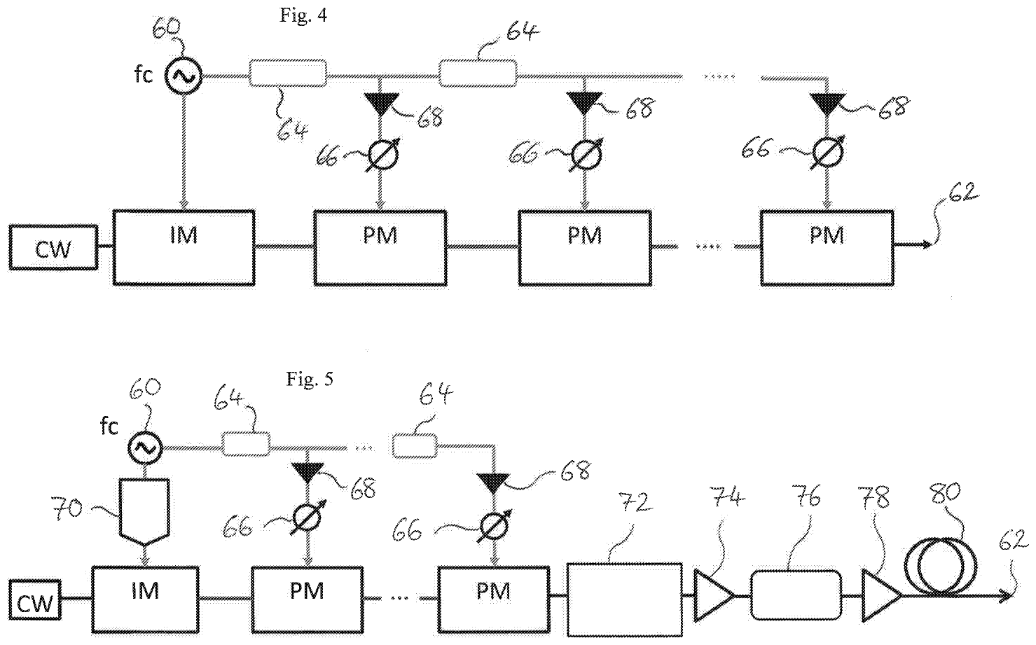

FIG. 4 is a schematic illustration of an optical frequency comb generator according to a further embodiment of the invention; and

FIG. 5 is a schematic illustration of an optical frequency comb generator according to a further embodiment of the invention.

In the drawings, like parts are given like reference signs, and duplicate description thereof is omitted. Terms such as “photonic”, “optical” and “light” used herein do not limit the subject matter in any way to visible light, but encompass any suitable region of the electromagnetic spectrum, including at least infra-red (IR), visible, and ultra-violet (UV).

A first embodiment of the invention is illustrated in FIG. 1. A first continuous wave laser source CW1 seeds a frequency comb generator 10, which produces a first frequency comb 12 comprising a range of discrete, evenly spaced frequencies (f) referred to as ‘tones’ (or comb lines). The term ‘frequency comb’ will on occasion be abbreviated to ‘comb’ herein for conciseness. The comb generator 10 can be any conventional or novel comb generator, for example: an electro-optical frequency comb generator consisting of cascaded intensity modulators and phase modulators (discussed further below); a Kerr frequency comb generator; a highly non-linear fiber-based comb generator; a Fabry-Perot cavity based opto-electronic comb generator; mode-locked lasers under injection-locking.

A second continuous wave laser source CW2 also seeds the comb generator 10. The outputs of lasers CW1 and CW2 are combined using a coupler or wavelength multiplexer (not shown) and input to the comb generator 10. The comb generator 10 outputs a second frequency comb 14 based on the seeding by the second laser source CW2. The lasers CW1 and CW2 are of different frequency (i.e. different wavelength) (i.e. peak or center frequency), so the first and second combs 12, 14 are displaced such that the high frequency tones of the first comb 12 and the low frequency tones of the second comb 14 are overlapped in the frequency domain in a region of overlap 16.

A portion of the output light of the comb generator 10 is split off (e.g. using a splitter or tap coupler, not shown) to an optical filter 20 that passes the light only in the region of overlap 16 (i.e. the optical filter 20 is a spectral filter that spectrally filters the light); indeed the optical filter 20 may pass the light from only a sub-range of frequencies within the overall region of overlap 16. Any suitable optical filter can be used, for example a grating or thin-film filter. The filtered light can comprise one or several pairs of tones, each pair of tones consisting of one tone originating from the first laser source CW1 and one tone originating from the second laser source CW2. In this context, a tone from each of two sources are considered a ‘pair’ when they are closest to each other in frequency. A single pair of tones is illustrated schematically in the frequency plot 22. The filtered light is passed to a feedback control apparatus 24, where it is detected, analyzed, and used to produce one or more error signals which are used to control either or both of the laser sources CW1, CW2 seeding the comb generator 10, and/or to control optical components in the optical path between either or both laser sources and the comb generator 10. In the illustrated embodiment, the feedback is used to control the wavelength (frequency) of CW2, and to adjust an optical phase shifter 26 to control the phase of the light from CW2. By using the feedback control apparatus 24, the frequency and phase of the pair of tones in the overlap region 16 can be locked, such that the frequencies and phases are substantially aligned (it is preferably arranged that the pair of tones constructively combine with zero phase difference, but they can also be locked or aligned at some other constant, non-zero phase angle). In this way, the phase and frequency of the first comb 12 and second comb 14 become coherent, forming effectively a single coherent wide bandwidth comb 28.

The feedback control apparatus 24 will now be explained with reference to FIG. 2. The light from the overlap region 16 of the combs, that is passed by the optical filter 20, is detected by a photodiode (PD) or other suitable photodetector. Depending on the design of optical filter 20, the filtered light may not be just a single pair of tones, but can be multiple pairs, as illustrated in the spectrum 30 at the input to the photodiode. The electrical signal from the photodiode comprises the beat frequency of each pair of tones, and the different pairs generate different beat frequencies, as illustrated by the spectrum 32. An optional signal filter 34, such as an electronic filter or digital filter, being a low-pass filter or bandpass filter, can be used to extract one beat note (e.g. the highest power beat note, see spectrum 36) for use in feedback. If the optical filter 20 extracts a single pair of tones, then the signal filter 34 can be omitted.

The beat note carries the frequency and phase difference of the two combs 12, 14. The beat note is electronically detected by a phase frequency detector (PFD) 38 (e.g. a phase locked loop or linear electronic frequency discriminator) which generates an error signal corresponding to the phase and frequency variation of the beat note signal. The error signal is passed to a feedback controller 40, such as a proportional-integral-derivative (PID) controller, which outputs control signals to adjust the frequency and phase of the light received by the comb generator 10 from the second laser source CW2 (it could equally control the first laser source CW1, or both). Various control signals can be output by the feedback controller 40, including: a fast loop phase control signal 42 to adjust the optical phase shifter 26 (or phase modulator); a control signal 44 for adjusting the frequency of the continuous wave laser source CW2; and, optionally, there can be a slow feedback loop signal 46 for controlling the long-term frequency deviation of the laser source(s), typically caused by thermal drift.

When the pair of comb tones in the overlapping region 16 are perfectly aligned in frequency and at constant phase, then the beat note frequency becomes zero, as does the error signal, and the two combs 12, 14 are stitched together to form the wider coherent comb 28.

FIG. 3 shows an embodiment of the invention in which the dual seed lasers of FIG. 1 is extended to multiple seed lasers. The outputs of N continuous wave lasers CW1, CW2, . . . CWN (in principle, N can be any natural number>2; FIG. 1 covers the case of N=2) are combined and simultaneously passed through a comb generator 10, to produce N combs each with limited bandwidth, but overlapping and distributed in frequency space. A bank of optical filters 20 is provided, each centered at a different wavelength.

The first optical filter 20.1 extracts tones in the region of overlap 50 between the first and second combs; the second optical filter 20.2 extracts tones in the region of overlap 52 between the second and third combs, and so on up to the (N-1)th optical filter 20.N-1 that extracts tones in the region of overlap between the (N-1)th and Nth combs. The filtered light is then processed by a feedback control apparatus 24 that is now an array of N-1 feedback control apparatuses 24 as explained above, for example with reference to FIG. 2. In this way, the multiple combs are overlapped and combined, with constant frequency and phase difference, to result in a flat wideband comb 28. The frequency and phase are stabilized using a feedback loop as explained with reference to FIG. 2. In alternative embodiments, the feedback control apparatus 24 can comprise: N-1 discrete feedback control apparatuses (for example each of the type illustrated in FIG. 2); or can comprise a unitary feedback control apparatus that detects and processes the N-1 input signals in parallel or sequentially; or an intermediate combination of these alternatives.

Examples of comb generators 10 will now be described, which can be used in the above-described embodiments of optical frequency comb generation apparatus, or which can be used as stand-alone embodiments of comb generators.

FIG. 4 shows an optical frequency comb generator that uses a continuous wave source CW as a seed light source. The light is modulated by an intensity modulator IM (for example a Mach-Zehnder modulator, MZM) and a series of phase modulators PM, all of which are driven by a sinusoidal signal from the same RF source 60 at frequency fc. Preferably the seed light source CW is a wavelength tunable laser with narrow linewidth (e.g. <1 kHz linewidth). The intensity modulator IM shapes a pulse, and the first phase modulator PM is strongly modulates it (e.g. 6−8×π phase modulation) to generate a strong chirp, and consequently a flat frequency comb is generated at output 62. The number of optical tones is increased by adding more phase modulator PM stages. The RF signals that drive the phase modulators PM and the intensity modulator IM need to have the same phase to generate a flat spectrum, so phase shifters 64 are included in the electronic signal path for fine tuning the phase. The spacing (frequency difference) between neighboring comb tones can be tuned by changing the frequency of the driving RF signal fc.

Adjusting the power that drives the phase modulators PM enables the bandwidth of the comb (number of tones) to be tuned. This is achieved by an adjustment apparatus, which in this embodiment comprises a tunable RF attenuator 66 for each phase modulator PM, to adjust the RF power applied to the phase modulators. Optionally, in this embodiment, an RF amplifier 68 is provided in the electrical signal path prior to each tunable RF attenuator, to boost the RF signal before it is attenuated. These can be fixed gain RF amplifiers 68. In an alternative embodiment, tunable gain RF amplifiers can be used (with or without attenuators 66) to adjust the RF power that drives the phase modulators.

Accordingly, an optical frequency comb generator is achieved that is tunable in bandwidth, and can generate a flat, low noise spectrum.

A further embodiment of an optical frequency comb generator is illustrated in FIG. 5 which is an extension of that of FIG. 4, so description of the corresponding parts will be omitted to avoid repetition.

The comb generation apparatus of FIG. 5 further comprises a driver 70 for controlling the electrical signal that drives the intensity modulator IM. Suitable drivers include an electronic pulse shaper (e.g. nonlinear electronic device) or digital-to-analog converter. The driver 70 can be used (by driving the intensity modulator) to pre-shape (or pre-distort) the optical pulse (including pulse width and peak power); and, by controlling the pulse shape, the resulting optical frequency comb bandwidth and comb spacing can be controlled. This avoids the need to use other optical components for pulse shaping (such as optical fiber with a nonlinear loop mirror or a waveshaper) which can be expensive and bulky.

The output of the cascaded modulators can, optionally, be passed through a comb expansion stage, shown by the components to the right of FIG. 5. These comprise: a fixed passive pulse compressor 72 (e.g. a fixed grating or fixed length of fiber); a first optical amplifier 74 (e.g. an erbium-doped fiber amplifier, EDFA); a comb filter 76; a second optical amplifier 78 acting as a booster; and an optically nonlinear medium 80 (e.g. a highly nonlinear fiber or waveguide). Using such an expansion stage can, for example, expand the comb bandwidth to 100s of nm.

The comb filter 76 is an optical filter that passes the tones, but filters out the noise between the tones, to increase the optical signal to noise ratio (OSNR), before pumping the nonlinear medium 80. In one example, the comb filter is Fabry-Perot filter with high finesse (e.g. finesse>1000) and with free spectral range (FSR) equal to the comb spacing (fc). In other examples, the comb filter 76 is a high resolution waveshaper, a ring filter, or cascaded fiber Bragg gratings. Depending on the maximum power handling capability, the comb filter 76 can be included between the first optical amplifier 74 and the second optical amplifier 78, as illustrated, or can be after the second optical amplifier 78 (booster amplifier).

The use of the driver 70 to shape the waveform to drive the intensity modulator IM to shape the optical pulse, means that a fixed passive compressor 72 can be used to achieve the optimum pulse shape to pump the nonlinear medium 80, instead of requiring an active, tunable optical pulse shaper. A desired optical pulse shape can be achieved using digital signal processing methods or machine learning methods (for example using feedback from the comb output 62 to control the driver 70). In this way, the driver 70 generates the desired waveform that drives the intensity modulator IM, the light from which, after passing through all the components in the optical signal chain, generates a desired pulse that pumps the nonlinear medium 80 to generate a desired comb spectrum (e.g. flat, wide bandwidth, low noise). The comb is tunable by changing the signal applied by the driver 70 to the intensity modulator IM.

In addition, generation of asymmetrically shaped pulses using the above scheme can allow for tailoring of the comb spectrum to target specific wavelength regions. The shape of the optical pulses strongly affects the shape of the comb spectrum generated after the modulators IM, PM. In addition, the symmetry of the pulses entering the nonlinear medium 80 determines the overall flatness and bandwidth expansion of the comb. Using tailored asymmetric pulses created by pre-distorting the waveform enables the creation of skewed or asymmetric comb broadening which can target, for example, longer or shorter wavelengths.

In alternate embodiments, each of the additional components of FIG. 5, including the driver 70, pulse compressor 72, and comb filter 76 can, optionally, be omitted or used separately, individually or in any combination. Furthermore, although FIGS. 4 and 5 show a single intensity modulator followed by several phase modulators, that is merely one example. The feature shared by embodiments is having a series of one or more cascaded modulators, which can comprise more or fewer of each type of modulator, and in any sequence. It is also contemplated that the continuous wave laser source CW and the intensity modulator IM of FIGS. 4 and 5 be replaced by an intensity modulated laser source, such as a mode-locked laser or other pulsed or time-modulated laser source, which would then be followed by at least one phase modulator and any number of intensity modulators (including zero, one or more).

1. An optical frequency comb generation apparatus comprising:
a comb generator arranged to receive light simultaneously from a plurality of continuous wave laser sources of different frequency, and to produce a combined output comprising a combination of a plurality of frequency combs, one comb for each laser source, wherein the frequency combs span different frequency bands, and wherein the comb from a first laser source at least partially overlaps in frequency with an adjacent comb from a second laser source in a region of overlap;
a spectral filter arranged to receive a portion of the combined output and to selectively produce a filtered output comprising at least one pair of tones from the region of overlap, the pair of tones comprising one tone from the comb from the first laser source and one tone from the comb from the second laser source;
a feedback control apparatus arranged to receive the filtered output of the spectral filter and to produce, based on the filtered output, at least one control signal arranged to adjust the light entering the comb generator such that the frequencies and phases of the pair of tones from the region of overlap are substantially aligned.

2. An apparatus according to claim 1, wherein the combined output comprises a synthesized single comb comprising evenly spaced tones spanning a band of frequencies wider than the frequency band of a comb produced by the comb generator from an individual one of the laser sources.

3. An apparatus according to claim 1, wherein the feedback control apparatus comprises:
a photodetector to convert the filtered output to an electrical signal containing a beat note from the pair of tones from the overlap region; and
a phase frequency detector to detect, from the electrical signal, the phase difference and frequency difference of the pair of tones.

4. An apparatus according to claim 3, wherein the at least one control signal produced by the feedback control apparatus is arranged to minimize the phase difference and frequency difference of the pair of tones.

5. An apparatus according to claim 1, further comprising an optical phase shifter, wherein a control signal from the feedback control apparatus is used to adjust the phase of the light received by the comb generator from at least one of the laser sources by adjusting the optical phase shifter.

6. An apparatus according to claim 1, wherein a control signal from the feedback control apparatus is used to adjust the frequency of the light output by one of the laser sources and received by the comb generator.

7. An apparatus according to claim 1, wherein the number of laser sources is N, where N>2, and wherein the apparatus comprises up to N 1 of said feedback control apparatuses and N 1 respective spectral filters.

8. An apparatus according to claim 1, wherein the comb generator comprises:
a series of cascaded optical modulators comprising at least one intensity modulator and at least one phase modulator;
a generator for generating an oscillatory electrical signal for driving the modulators; and
an adjustment apparatus arranged to adjust the amplitude of the oscillatory electrical signal applied to at least one of the modulators.

9. An apparatus according to claim 8, comprising a plurality of phase modulators, and wherein the adjustment apparatus is arranged to adjust the amplitude of the oscillatory electrical signal applied to each phase modulator.

10. An apparatus according to claim 9, wherein the adjustment apparatus is arranged such that the electrical signal applied to each phase modulator is individually adjustable.

11. An apparatus according to claim 9, wherein the adjustment apparatus comprises at least one of: a variable attenuator; and an amplifier with variable gain.

12. An apparatus according to claim 8, wherein the adjustment apparatus comprises a controllable electronic pulse shaper arranged to shape the oscillatory electrical signal that is then applied to the intensity modulator.

13. A method of generating an optical frequency comb comprising:
passing light simultaneously from a plurality of continuous wave laser sources of different frequency through a comb generator to produce a combined output comprising a combination of a plurality of frequency combs, one comb for each laser source, wherein the frequency combs span different frequency bands, and wherein the comb from a first laser source at least partially overlaps in frequency with an adjacent comb from a second laser source in a region of overlap;
spectrally filtering a portion of the combined output to produce a filtered output comprising at least one pair of tones from the region of overlap, the pair of tones comprising one tone from the comb from the first laser source and one tone from the comb from the second laser source;
applying feedback control, based on the filtered output of the spectral filter, to produce at least one control signal arranged to adjust the light entering the comb generator such that the frequencies and phases of the pair of tones from the region of overlap are substantially aligned.

14. An optical frequency comb generator comprising:
a series of cascaded optical modulators comprising at least one phase modulator and at least one intensity modulator or intensity-modulated laser source;
a generator for generating an oscillatory electrical signal for driving the modulators; and
an adjustment apparatus arranged to adjust the oscillatory electrical signal applied to at least one of the modulators.

15. An apparatus according to claim 14, comprising a plurality of phase modulators, and wherein the adjustment apparatus is arranged to adjust the amplitude of the oscillatory electrical signal applied each phase modulator.

16. An apparatus according to claim 15, wherein the adjustment apparatus is arranged such that the electrical signal applied to each phase modulator is individually adjustable.

17. An apparatus according to claim 15, wherein the adjustment apparatus comprises at least one of: a variable attenuator; and an amplifier with variable gain.

18. An apparatus according to claim 17, wherein the or each variable attenuator is a tunable RF attenuator.

19. An apparatus according to claim 14, wherein the adjustment apparatus comprises a controllable electronic pulse shaper arranged to shape the oscillatory electrical signal that is then applied to the intensity modulator.
